(19) United States
(12) Patent Application Publication
(10) Pub. No.: US 2018/0319074 A1
(43) Pub. Date: Nov. 8, 2018

(54) METHOD OF FORMING A FLARE ON TUBING

(71) Applicant: Cook Medical Technologies LLC, Bloomington, IN (US)

(72) Inventor: Drew P. Lyons, Ellettsville, IN (US)

(73) Assignee: Cook Medical Technologies LLC, Bloomington, IN (US)

(21) Appl. No.: 15/969,341

(22) Filed: May 2, 2018

Related U.S. Application Data
(60) Provisional application No. 62/500,452, filed on May 2, 2017.

(51) Int. Cl. B29C 57/04

(52) U.S. Cl. CPC B29C 57/04; B29L 2023/22; B29K 2905/00; B29K 2909/02

(57) ABSTRACT

A method of forming a flare on an end portion of a polymer elongated member may be provided including positioning the elongated member within a passageway of a holding apparatus, heating an end portion of the elongated member, pressing a die onto the end portion of the elongated member, and advancing a press onto the end portion of the elongated member. The passageway may include a recess defined by a recess wall extending from a first end coextensive with a forming side of the holding apparatus to an internal second end. When the die is pressed on to the end portion of the elongated member, the end portion of the elongated member may be compressed longitudinally and expands radially. When the press is advanced onto the end portion of the elongated member, an inner section of the end portion may be folded against an outer section of the end portion.

### CROSS-REFERENCE

The present application is a continuation of and claims priority to U.S. Provisional Patent Application 62/500,452, “Method of Forming a Flare on Tubing” filed on May 2, 2017, which is incorporated by reference in its entirety.

### TECHNICAL FIELD

This disclosure relates to medical tubing for use in medical procedures and, in particular, to flared ends of medical tubing used to accommodate a tube-to-hub connection joint.

### BACKGROUND

The statements in this section merely provide background information related to the present disclosure and may not constitute prior art.

Tubing, such as catheters and sheaths, are commonly connected to a hub connection joint. A flared end of the tubing is commonly used to secure the end of the tubing within the hub. Commonly, the flared end is formed by stretching the diameter of the end of the tubing to create a tapered flare. However, by stretching the diameter of the end of the tubing, the wall thickness of the tubing at the flared end is decreased. A smaller wall thickness creates a greater risk that the connection between the tubing and the hub could fracture during use, which could be severely detrimental during surgical operations, potentially creating a health risk for the patient. It is desirable to have a method of forming a flared end which has thicker wall thickness and is less vulnerable to fracturing.

### SUMMARY

Further areas of applicability will become apparent from the description provided herein. It should be understood that the description and specific examples are intended for purposes of illustration only and are not intended to limit the scope of the present disclosure.

In one embodiment, a method of forming a flare on an end portion of a polymer elongated member is provided including positioning the elongated member within a passageway of a holding apparatus, heating an end portion of the elongated member, pressing a die onto the end portion of the elongated member, and advancing a press onto the end portion of the elongated member. The holding apparatus comprises a forming side and a non-forming side. An end portion of the passageway includes a recess defined by a recess wall extending from a first end coextensive with the forming side of the holding apparatus to an internal second end. When positioning the elongated member within the passageway, the end portion of the elongated member extends from the second end of the recess wall beyond the first end of the recess wall. When the die is pressed on to the end portion of the elongated member, the end portion of the elongated member compresses longitudinally and expands radially. When the press is advanced onto the end portion of the elongated member, an inner section of the end portion is folding against an outer section of the end portion.

In another embodiment, a method of an end portion of a polymer elongated member for a fitting is provided comprising positioning the elongated member into a passageway of a holding apparatus, pressing a die onto an end portion of the elongated member, advancing a female fitting portion over the end portion of the elongated member, and advancing a male fitting portion onto the female fitting portion. While positioning the elongated member into the passageway, the end portion of the elongated member extends outwardly through a forming side of the holding apparatus. While pressing the die onto the end portion of the elongated member, the end portion compresses longitudinally and expands radially. While advancing the male fitting portion into the female fitting portion, the end portion of the elongated member is compressed between the female fitting portion and the male fitting portion. An inner section of the end portion is folded against an outer section of the end portion.

In yet another embodiment, a system for forming a flare in an end portion of a polymer elongated member is provided comprising a holding apparatus, a heated die, and a press. The holding apparatus comprises a forming side, a non-forming side, and a passageway configured to receive the elongated member. An end portion of the passageway includes a recess defined by a recess wall having a conical surface extending from a first end coextensive with the forming side of the holding apparatus to an internal second end. The heated die comprises a surface configured to engage the end portion of the elongated member and a stud configured to extend into a lumen of the elongated member. The press has a surface configured to compress the end portion of the elongated member against the conical surface of the recess.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a perspective view of a first example of a holding apparatus and an elongated member;

FIG. 2 illustrates a cross-sectional perspective view of the first example of the holding apparatus and elongated member shown in FIG. 1;

FIG. 3 illustrates a cross-sectional perspective view of the first example of the holding apparatus and the elongated member shown in FIG. 1, as well as an example of a die;

FIG. 4 illustrates a cross-sectional side view of the first example of the holding apparatus and the elongated member shown in FIG. 1, as well as an example of a press;

FIG. 5 illustrates a perspective view of the elongated member shown in FIG. 1 having a flared end portion.

FIG. 6 illustrates a cross-sectional perspective view of a second example of a holding apparatus, an elongated member, and a die;

FIG. 7 illustrates a cross-sectional perspective view of a third example of a holding apparatus, an elongated member, and a press;

FIG. 8 illustrates a cross-sectional side view of a first example of a male fitting portion, a first example of a female fitting portion, and a fourth example of an elongated member;

FIG. 9 illustrates a cross-sectional side view of a second example of a male fitting portion and a second example of a female fitting portion; and

FIG. 10 illustrates a flow diagram of operations to form a flare on an end portion of an elongated member.

The drawings described herein are for illustration purposes only and are not intended to limit the scope of the present disclosure in anyway.

### DETAILED DESCRIPTION

The following description is merely exemplary in nature and is not intended to limit the present disclosure, application, or uses.

In one example, a method of forming a flare on an end portion of a polymer elongated member is provided including positioning the elongated member within a passageway of a holding apparatus, heating an end portion of the elongated member, pressing a die onto the end portion of the elongated member, and advancing a press onto the end portion of the elongated member. The holding apparatus comprises a forming side and a non-forming side. An end portion of the passageway includes a recess defined by a recess wall extending from a first end coextensive with the forming side of the holding apparatus to an internal second end. When positioning the elongated member within the passageway, the end portion of the elongated member extends from the second end of the recess wall beyond the first end of the recess wall. When the die is pressed on to the end portion of the elongated member, the end portion of the elongated member compresses longitudinally and expands radially. When the press is advanced onto the end portion of the elongated member, an inner section of the end portion is folding against an outer section of the end portion.

One technical advantage of the systems and methods described below may be that the flared end portion of the elongated member may have a sufficient wall thickness to prevent fracturing or cracking when placed in a hub fitting. Another technical advantage may be that the method may be used for a variety of sizes of the elongated member.

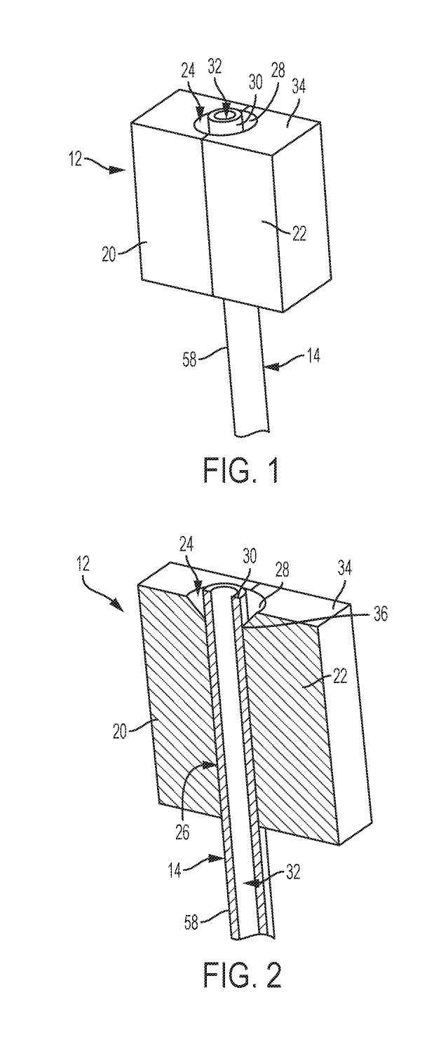

FIGS. 1 and 2 illustrate an elongated member 14 positioned within a passageway 26 of a holding apparatus 12. The elongated member 14 may be any object which is configured to extend intraluminally within the body of a patient. Examples of the elongated member 14 may include tubing such as a catheter or a sheath. The elongated member 14 may include a lumen 32 extending longitudinally through the elongated member 14. The elongated member 14 may include a central portion 58 and an end portion 30. The end portion of the elongated member 14 may be configured to form a flare at the end of the elongated member 14. The elongated member 14 may be made of any polymer material such as polyurethane, polytetrafluoroethylene (PTFE), and nylon.

The holding apparatus 12 may be any object which is configured to receive and hold the elongated member 14. Examples of the holding apparatus 12 may include a clamp or a block. The holding apparatus 12 may be made from any material capable of holding the elongated member 14 including, for example, stainless steel or a high melting point polymer such as polyether ether ketone (PEEK). In some embodiments, the holding apparatus 12 may be made of a ceramic material to limit thermal transmission to the central portion 58 of the elongated member 14 from the holding apparatus 12. The holding apparatus may also comprise a forming side 34 of the clamp where the flared end portion 30 of the elongated member 14 is formed and a non-forming side (not shown).

The passageway 26 of the holding apparatus 12 may be any opening within the holding apparatus 12 which is configured to receive and fix the position of the elongated member 14. The passageway 26 may be linear, cylindrical, or curved. The passageway 26 may be defined by the interacting surfaces of a first portion 20 and a second portion 22 of the holding apparatus 12. When the first portion 20 and second portion 22 meet, the passageway 26 may be defined by the interacting surfaces of the respective first portion 20 and second portion 22. The passageway 26 may have a minimum diameter that is equal to or slightly less than the elongated member 14 such that the elongated member 14 may be placed within the passageway 26 and such that the longitudinal position of the elongated member 14 is frictionally held by the interaction between the surface of the passageway 26 and the outer surface of the central portion 58 of the elongated member 14.

The passageway 26 may include an end portion at the forming side 34 of the holding apparatus 12 which includes a recess 24. The recess is defined by a recess wall 28 which may extend from a first end coextensive with a surface of the forming side 34 of the holding apparatus 12 to a second end 36 which is located in the passageway 26, on the interior of the holding apparatus 12. The recess wall 28 may be a conical surface extending from the first end to the second end 36 of the recess wall 28. The elongated member 14 may be positioned in the passageway that the end portion 30 of the elongated member 14 extends from the second end 36 of the recess wall 28, outwardly to a point located beyond the first end of the recess wall 28 and the forming side 34 of the holding apparatus 12.

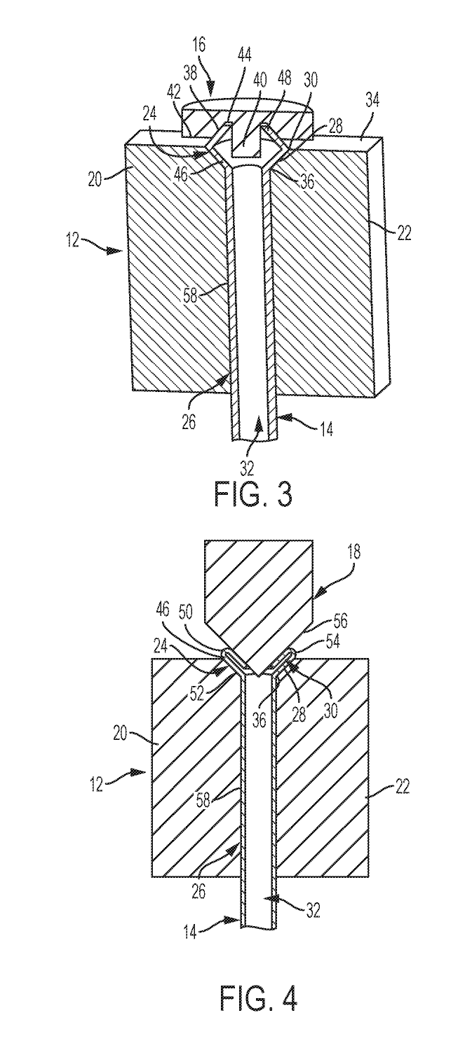

FIG. 3 illustrates a die 16 being pressed onto the end portion 30 of the elongated member 14. After the end portion 30 of the elongated member 14 has been positioned in the passageway 26 of the holding apparatus 12, the end portion 30 of the elongated member 14 may be heated to a temperature sufficient to cause a change of state or a partial change of state in the end portion 30 such as a molten or partially liquefied physical state. In one embodiment, the end portion 30 is heated by pressing the die 16 on to the end portion 30 of the elongated member 14 after heating the die 16 or while heating the die 16. In other embodiments, the end portion 30 of the elongated member 14 may be heated by an external heat source before the die 16 is applied to the end portion 30. The end portion 30 may be heated to a temperature between 250 and 650 degrees Fahrenheit. In an embodiment wherein the die 16 is heated, the die 16 may be heated to a temperature between 250 and 650 degrees Fahrenheit.

The die 16 may any object which, when applied to the end portion 30 of the elongated member 14, causes the end portion 30 to compress longitudinally, along a longitudinal axis passing through the central portion 58 and end portion 30 of the elongated member 14, and causes the end portion 30 to expand radially, orthogonal to the longitudinal axis. Examples of the die 16 include shaped block or a carved workpiece. The die 16 may be made of any material which may be used to shape the polymer of the end portion 30. In some embodiments, the die 16 may be made of a material with high thermal conductivity, such as brass, steel, or aluminum, which can be used to transfer heat from die 16 to the end portion 30. The die 16 may comprise a surface 38 extending from a first end coextensive with an internal surface 44 within the interior of the die 16 to a second end coextensive with a side 42 of the die 16. To transmit heat from the die 16 to the end portion 30, the surface 38 may be metal. The surface 38 of the die 16 may be conical in shape. The die 16 may also include a stud 40 extending outwardly from the internal surface 44 of the die 16 to a point located beyond the side 42 of the die 16. The stud 40 may be configured to extend into the lumen 32 of the elongated member 14 when the die 16 is pressed onto the end portion 30 of the elongated member 14. The stud may have a sufficient length such that when the die is pressed onto the end portion 30, the stud extends into the passageway 26 of the holding apparatus 12 to a point beyond the second end 36 of the recess wall 28. In some embodiments, the stud 40 may be made of different material than the die 16, such as a ceramic, which prevent heat transfer from the stud 40 to the central portion 58 of the elongated member 14. The internal surface 44 of the die may sized to form a step placed between the first end of the surface 38 and a base of the stud 40. In other embodiments, the first end of the surface 38 may be at the base of the stud 40 such that the internal surface 44 of the die 16 is de minimis.

In some embodiments, when the die 16 is pressed onto the end portion 30 of the elongated member 14, the longitudinal compression and radially expansion of the end portion 30 may create a fold (54 in FIG. 4) in the end portion 30 creating an inner section 48 of the end portion which rests against the surface 38 of the die 16 and an outer section 46 which rests against the recess wall 28 of the holding apparatus 12. In some embodiments, the side 42 of the die 16 may contact the forming side 34 of the holding apparatus 12 forming a chamber defined by the surface 38 of the die 16, the recess wall 28 of the holding apparatus 12, and a surface of the stud 40. The stud 40 of the die 16 may be arranged to prevent the inner section 48 and outer section 46 of the end portion from occluding the lumen 32 of the elongated member 14.

FIG. 4 illustrates a press 18 being advanced onto the end portion 30 of the elongated member 14 after the die 16 has been removed. The press 18 may be any object which, when advanced against the end portion 30, causes the inner section 48 of the end portion 30 to fold inward and against the outer section 46 of the end portion 30. Examples of the press 18 may include a conical workpiece or a cylindrical block. The press 18 may be made from any material sufficient to fold the end portion 30, such as aluminum, stainless steel, ceramic, or other materials. The press 18 may include a surface 56 configured to engage the inner section 48 of the end portion 30 and fold it against the outer section 46. The surface 56 of the press may be conical. In some embodiments, when the inner section 48 of the end portion 30 is folded against the outer section 46, the end portion 30 is sufficiently heated that the inner section 48 and outer section 46 fuse together to form a solid flared end portion 30 having a wall thickness which is greater than a wall thickness of the central portion 58 of the elongated member 14. The press 18 may be heated prior to being applied to the end portion 30 to heat and better shaped the end portion 30. To prevent fracturing of the flared end portion 30, the wall thickness of the flared end portion 30 may be at least 0.015 inches.

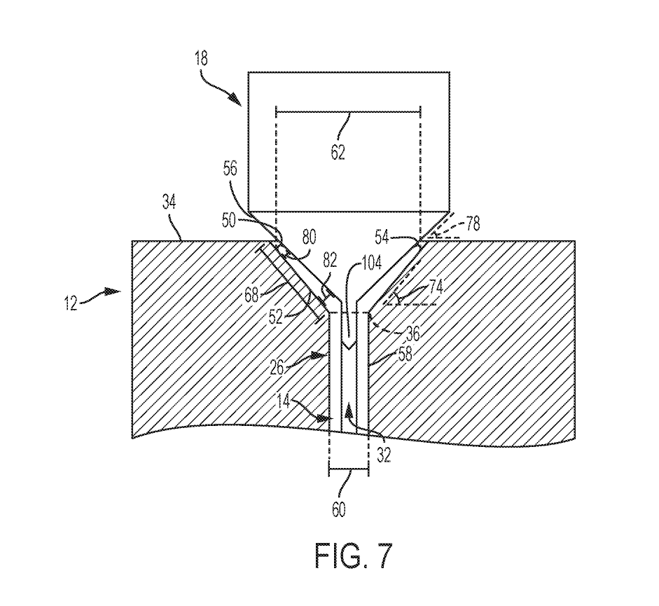

In some embodiments, the press 18 may include a stud portion (104 in FIG. 7) similar in shape and function to the stud 40 of the die 16. The stud portion 104 may extend outward from the center of the surface 56 of the press 18. The stud portion 104 may be configured such that when the press 18 is advanced onto the end portion 30, the stud portion 104 extends into the lumen 32 of the elongated member 14 to prevent the inner section 48 from occluding the lumen 32 and to prevent an edge from forming at the point where the inner section 48 and outer section 46 are fused together.

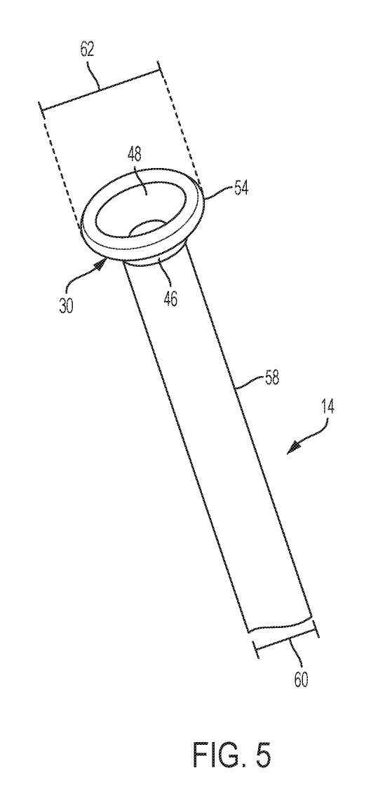

FIG. 5 illustrates the elongated member 14 having a flared end portion 30 after being removed from the passageway 26 of the holding apparatus 12. The central portion of the elongated member 14 may have a diameter 60 between 2 and 40 on the French catheter scale. The flared end portion 30 may have a diameter 62 between 0.025 inches and 0.6 inches.

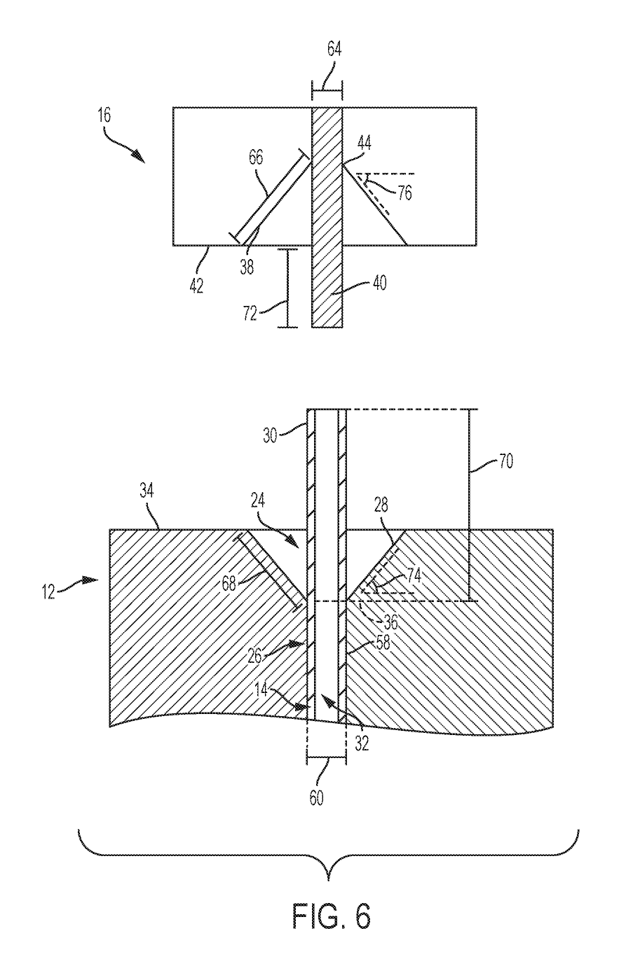

FIG. 6 illustrates a cross-sectional view of an example of the holding apparatus 12, the elongated member 14, and the die 16. In some embodiments, the recess wall 28 may be conical such that the recess wall 28 has an angle of inclination 74 between 0 and 80 degrees with respect to the surface of the forming side 34 of the holding apparatus 12. The surface 38 of the die 16 may also be conical such that surface 38 has an angle of inclination 76 between 0 and 80 degrees with respect to the surface of the side 42 of the die 16. In some embodiments, the angle of inclination 76 of the surface 38 of the die 16 may match the angle of inclination 74 of the recess wall 28 when reflected across a plane defined by a flat surface of the forming side 34 of the holding apparatus 12.

In some embodiments, a length 70 of the end portion 30 of the elongated member 14 extending outward from the second end 36 of the recess wall 28 may be critical to creating a sufficiently even and uniform flared end portion 30. If the end portion 30 is too long, the die 16 may not be able to create a proper fold 54 when pressed against the end portion 30. Furthermore, if the end portion 30 is too long, polymer material of the end portion 30 may occlude the lumen 32 of the elongated member when heated. If the end portion 30 is too short, the flared end portion 30 may have an uneven wall thickness or may have a wall thickness which is insufficient to prevent fracturing of the flared end portion 30. In some embodiments, the end portion 30 may extend from the second end 36 of the recess wall a length 70 no greater than a sum of a length 68 along the recess wall 28 from the first end to the second end 36 and a length 66 along the surface 38 of the die 16 from the first end to the second end.

As illustrated in FIG. 6, in some embodiments, the stud 40 has a diameter 64 which is less than diameter of the central portion 58 of the elongated member 14. In some embodiments, the diameter 64 of the stud 40 is equal to the diameter of the lumen 32 of the elongated member 14.

FIG. 7 illustrates a cross-sectional view of an example of the holding apparatus 12, the elongated member 14 having a flared end portion 30, and a press 18. The surface 56 of the press 18 may be conical such that surface 56 has an angle of inclination 78 between 0 and 80 degrees with respect to the surface of the forming side 34 of the holding apparatus 12. In some embodiments, the angle of inclination 78 of the surface 56 of the press 18 may match the angle of inclination 74 of the recess wall 28. In other embodiments, as illustrated in FIG. 7, the angle of inclination 78 of the surface 56 of the press 18 is shallower than the angle of inclination 74 of the recess wall 28. In such embodiments, where the end portion 30 has been previously heated, the difference in angles of inclination 74, 78 may cause more polymer material to collect toward an radially inward portion 52 of the flared end portion 30 than in a radially outward portion 50 of the flared end portion 30 when the press 18 is advanced onto the end portion 30. The flared end portion 30 in such an embodiment may have an inward portion 52 having a wall thickness 82 which is greater than a wall thickness 80 of an outward portion 50.

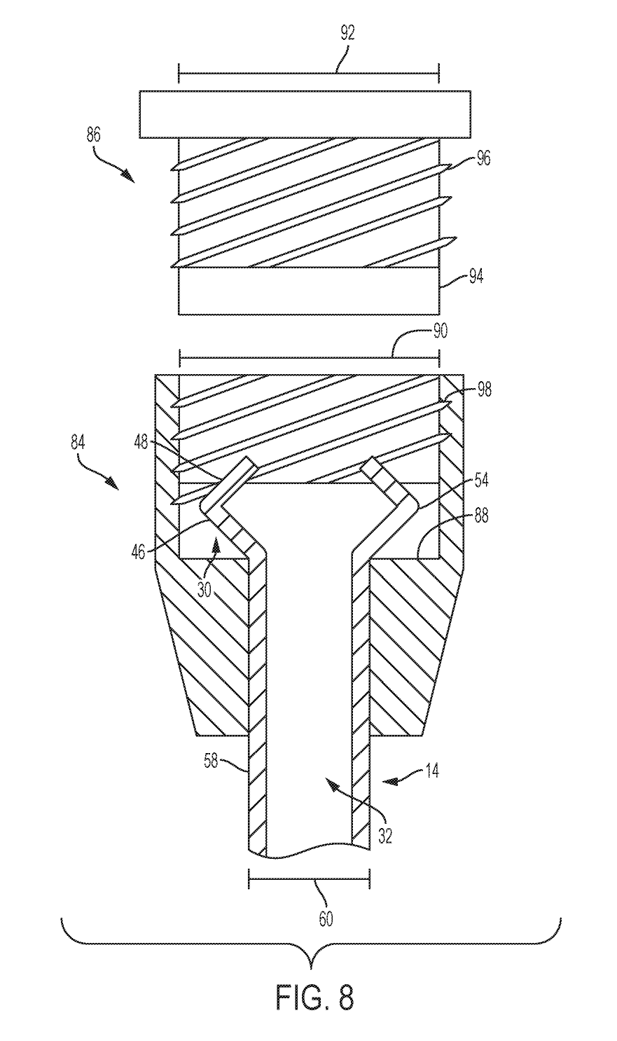

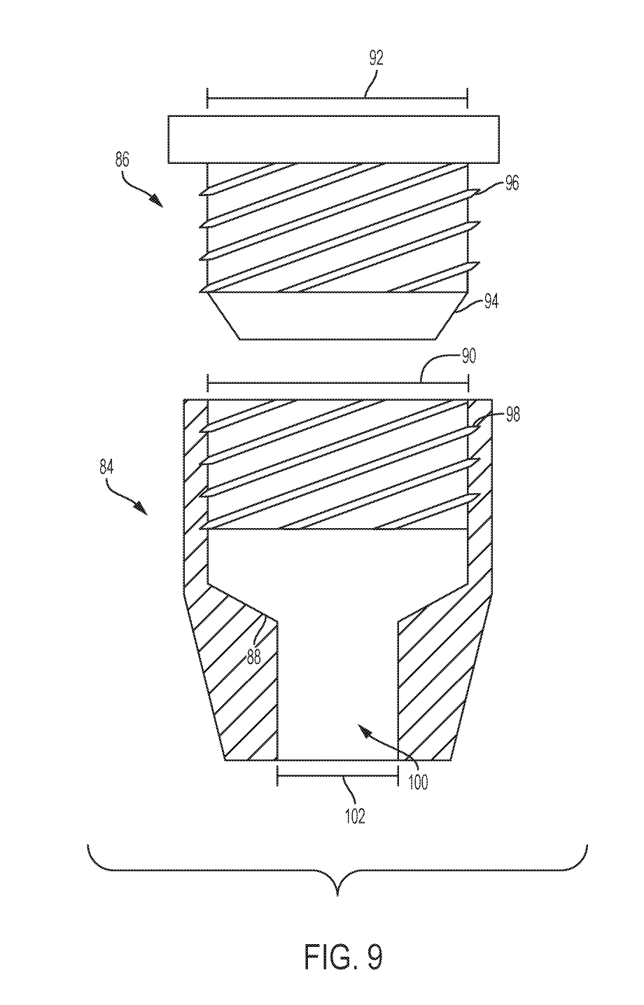

FIGS. 8 and 9 illustrate cross-sectional views of examples of a female fitting portion 84 and a male fitting portion 86. In some embodiments, after pressing the die 16 onto the end portion 30 of the elongated member 14, a female fitting portion 84 may be advanced over the end portion 30 of the elongated member 14. The female fitting portion 84 may be any object configured to receive and secure the flared end portion 30 of the elongated member 14 such as a cylinder or a hub. The female fitting portion 84 may have an opening (100 in FIG. 9) configured to be advanced over the elongated member 14. The opening 100 of the female fitting portion 84 may have a diameter (102 in FIG. 9) which is larger than the diameter 60 of the central portion 58 of the elongated member 14, and which is smaller than the diameter 62 of the flared end portion 30.

The female fitting portion 84 may also include an inner surface 88 and a sidewall 98. The inner surface 88 may surround the opening 100 and may be configured to engage the outer section 46 of the end portion 30 of the elongated member 14. The inner surface 88 may be flat, as shown in FIG. 8, or may be inclined, as shown in FIG. 9. Where the inner surface 88 is inclined, the inner surface 88 may have an angle of inclination which matches the angle of inclination 74 of the recess wall 28. In embodiments wherein, the inner surface 88 is flat, the elongated member 14 may be positioned within the passageway 26 of the holding apparatus 12 such that the end portion 30 extends from the second end 36 of the recess wall a length 70 no greater than a diameter 90 of the inner surface 88 subtracting the diameter 102 of the opening 100.

The diameter 90 of the inner surface 88 of the female fitting portion 84 is sized to receive a matching diameter 92 of a plunger 96 of the male fitting portion 86. The sidewall 98 of the female fitting portion 84 may be threaded to receive the threaded plunger 96 of the male fitting portion 86. The male fitting portion 86 may include a plunger end portion 94 arranged at an end of the plunger 96. A surface of the plunger end portion 94 may be configured to press against the inner surface 88 of the female fitting portion 84 when the elongated member 14 is not present. The surface of the plunger end portion 94 may also be configured to engage the inner section 48 of the end portion 30. Therefore, a surface of the plunger end portion 94 may be configured to match the inner surface 88 of the female fitting portion 84. For example, the surface of the plunger end portion 94 may be flat as illustrated in FIG. 8 or may be inclined, as illustrated in FIG. 9. An angle of inclination of the surface of the plunger end portion 94 may match the angle of inclination 74 of the recess wall 28 of the holding apparatus 12. After advancing the female fitting portion 84 over the end portion 30 of the elongated member 14, the male fitting portion 86 may be advanced into the female fitting portion 84 such that the end portion 30 is compressed between the inner surface 88 of the female fitting portion 84 and the surface of the plunger end portion 94 of the male fitting portion 86. While being compressed, the inner section 48 is folded against the outer section 46 of the end portion 30. The inner section 48 may be secured friction against the surface of the plunger end portion 94 of the male fitting portion 86. The outer section 46 may be secured by friction against the inner surface 88 of the female fitting portion 84.

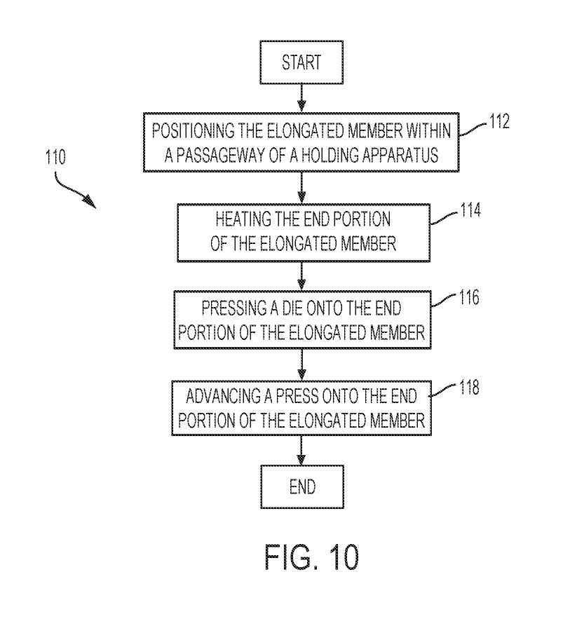

FIG. 10 illustrates a flow diagram of operations to form a flare on the end portion 30 of the polymer elongated member 14. The operations (110) may include fewer, additional, or different operations than illustrated in FIG. 10. Alternatively or in addition, the operations (110) may be performed in a different order than illustrated.

Initially, method of operations (110) includes positioning the elongated member 14 within the passageway 26 of the holding apparatus 12 (112). The end portion 30 of the elongated member 14 may extend from the second end of the recess wall 28 to a point beyond the forming side 34 of the holding apparatus 12. Once the elongated member 14 has been positioned, the method of operations (110) includes heating the end portion 30 of the elongated member 14 (114) and pressing the die 16 onto the end portion 30 of the elongated member such that the end portion 30 compresses longitudinally and expands radially (116). These steps (114, 116) may be done concurrently or separately. The method of operations (110) further includes advancing a press 18 onto the end portion 30 of the elongated member 14 such that the inner section 48 of the end portion 30 is folded against the outer section 46 of the end portion 30 (118).

In addition to the advantages that have been described, it is also possible that there are still other advantages that are not currently recognized but which may become apparent at a later time. While various embodiments have been described, it will be apparent to those of ordinary skill in the art that many more embodiments and implementations are possible. Accordingly, the embodiments described herein are examples, not the only possible embodiments and implementations.

What is claimed is:

1. A method of forming a flare on an end portion of a polymer elongated member comprising:
positioning the elongated member within a passageway of a holding apparatus the holding apparatus comprising a forming side and a non-forming side, an end portion of the passageway including a recess defined by a recess wall extending from a first end coextensive with the forming side of the holding apparatus to an internal second end, the end portion of the elongated member extending from the second end of the recess wall beyond the first end of the recess wall;
heating the end portion of the elongated member;
pressing a die onto the end portion of the elongated member such that the end portion compresses longitudinally and expands radially;
advancing a press onto the end portion of the elongated member such that an inner section of the end portion is folded against an outer section of the end portion.

2. The method of claim 1, wherein the recess wall comprises a conical surface extending from the first end to the second end of the recess wall such that a diameter of the recess at the first end is greater than a diameter of the recess at the second end.

3. The method of claim 2, wherein the press comprises a conical surface having an angle of inclination which matches an angle of inclination of the conical surface of the recess.

4. The method of claim 2, wherein the press comprises a conical surface having an angle of inclination which is shallower than an angle of inclination of the conical surface of the recess.

5. The method of claim 4, wherein after advancing the press onto the end portion of the elongated member, a wall thickness of an inward portion of the flared end portion is greater than a wall thickness of an outward portion of the flared end portion.

6. The method of claim 1, wherein the die comprises a conical surface extending from an internal first end to a second end coextensive with a side of the die, and a stud extending from the first end of the conical surface outwardly beyond the side of the die.

7. The method of claim 6, wherein the conical surface of the die has an angle of inclination which matches an angle of inclination of the conical surface of the recess when reflected across a plane defined by the forming side of the holding apparatus.

8. The method of claim 7, wherein while positioning the elongated member within the passageway, the end portion of the elongated member extends from the second end of the recess wall a length no greater than a sum of a length along the recess wall from the first end to the second end and a length of the conical surface of the die from the first end to the second end.

9. The method of claim 6, wherein the stud of the die has a length such that when pressing the die onto the end portion of the elongated member, the stud extends into the passageway of the holding apparatus beyond the second end of the recess wall.

10. The method of claim 1 further comprising heating the die before pressing the die onto the end portion.

11. The method of claim 1, further comprising, wherein while heating the end portion, changing a physical state of the polymer of the end portion.

12. A method of forming an end portion of a polymer elongated member for a fitting comprising:
positioning the elongated member into a passageway of a holding apparatus, an end portion of the elongated member extending outwardly through a forming side of the holding apparatus;
pressing a die onto the end portion of the elongated member such that the end portion compresses longitudinally and expands radially;
advancing a female fitting portion over the end portion of the elongated member; and
advancing a male fitting portion into the female fitting portion such that the end portion of the elongated member is compressed between the female fitting portion and the male fitting portion, and an inner section of the end portion is folded against an outer section of the end portion.

13. The method of claim 12, further comprising heating the die before pressing the die onto the end portion.

14. The method of claim 12, wherein the female fitting portion comprises a flat inner surface surrounding an opening through which the female fitting portion is advanced over the end portion of the elongated member, wherein the inner surface is configured to engage the end portion of the elongated member; and
wherein while positioning the elongated member into the holding apparatus, the end portion has a length which is no greater than a diameter of the inner surface subtracting a diameter of the opening of the female fitting portion.

15. The method of claim 12, wherein an end portion of the passageway includes a recess defined by a recess wall extending from a first end coextensive with the forming side of the holding apparatus to an internal second end, the recess comprising a conical surface extending from the first end to the second end of the recess wall such that a diameter of the recess at the first end is greater than a diameter of the recess at the second end.

16. The method of claim 15, wherein the female fitting portion comprises an conical inner surface surrounding an opening through which the female fitting portion is advanced over the end portion of the elongated member, wherein the conical inner surface is configured to engage the end portion of the elongated member and wherein the conical inner surface is arranged at an angle of inclination which matches an angle of inclination of the conical surface of the recess.

17. A system for forming a flare in an end portion of a polymer elongated member comprising:
a holding apparatus comprising a forming side, a non-forming side, and a passageway configured to receive the elongated member, an end portion of the passageway including a recess defined by a recess wall having a conical surface extending from a first end coextensive with the forming side of the holding apparatus to an internal second end;
a heated die comprising a surface configured to engage the end portion of the elongated member and a stud configured to extend into a lumen of the elongated member; and
a press having a surface configured to compress the end portion of the elongated member against the conical surface of the recess.

18. The system of claim 17, wherein the surface of the heated die is conical, extending from an internal first end a second end coextensive with a side of the heated die.

19. The system of claim 17, wherein the stud of the heated die is ceramic.

20. The system of claim 19, wherein the surface of the die comprises a metal.
